(19) United States
(12) Patent Application Publication
(10) Pub. No.: US 2011/0303363 A1
(43) Pub. Date: Dec. 15, 2011

(54) PLASMA PROCESSING APPARATUS

(75) Inventors: Masaki Hirayama, Sendai-shi (JP); Tadahiro Ohmi, Sendai-shi (JP)

(73) Assignees: TOKYO ELECTRON LIMITED, Tokyo (JP); TOHOKU UNIVERSITY, Sendai-shi (JP)

(21) Appl. No.: 13/148,179

(22) PCT Filed: Jan. 14, 2010
(86) PCT No.: PCT/JP2010/050321

§ 371 Date: Sep. 2, 2011

(30) Foreign Application Priority Data
Feb. 6, 2009 (JP) 2009-026270

(51) Int. Cl. C23F 1/08; H05H 1/24

(52) U.S. Cl. 156/345.35

(57) ABSTRACT

A microwave plasma processing apparatus for plasma-processing a substrate by exciting a gas by the microwave includes a processing container formed of metal, a microwave source for outputting the microwave, a first dielectric member that faces an inner wall of the processing container and for transmitting the microwave output from the microwave source into the processing container, and a second dielectric member that is provided on an inner surface of the processing container and restrains the microwave from propagating along the inner surface of the processing container.

### TECHNICAL FIELD

The present invention relates to a plasma processing apparatus for plasma-processing an object to be processed by exciting a gas by electromagnetic waves, and in particular, to a mechanism for controlling propagation of the electromagnetic waves.

### BACKGROUND ART

When microwaves of a low frequency are supplied to a plasma processing apparatus, ‘a surface wave propagating between a metal surface of an inner wall of a processing container and plasma’ (hereinafter, referred to as a metal surface wave (MSW)), as well as ‘a surface wave propagating between a dielectric member and plasma’ (hereinafter, referred to as a dielectric member surface wave (DSW)), are generated.

The MSW cannot propagate if a density of electrons in the plasma is less than twice of a cut-off density (n_{c}). The cut-off density (n_{c}) is proportional to a square of a frequency of the microwaves, and thus, the MSW cannot propagate if the frequency of the microwaves is low and the electron density is not high. In addition, it becomes difficult to attenuate the MSW as the frequency decreases.

At a frequency of 2450 MHz, which is generally used to generate plasma, a value of the cut-off density (n_{c}) is 7.5×10¹⁰ cm⁻³, and thus the MSW does not propagate unless the electron density is equal to 1.5×10¹¹ cm⁻³ or greater. For example, in low-density plasma having an electron density of about 1×10¹¹ cm⁻³ around a surface, the MSW does not propagate at all. Even if the electron density is higher than the above, the propagation of the MSW may not be a big problem in many cases since the attenuation is large.

On the other hand, at a frequency of 915 MHz, for example, the MSW propagates on an inner surface of the processing chamber for a long time even in low-density plasma having an electron density of about 1×10¹¹ cm⁻³ around the surface. Therefore, when the plasma process is performed by using low frequency microwaves, a unit for controlling the propagation of the MSW, in addition to a unit for controlling the propagation of the DSW, is necessary.

Therefore, the present inventor suggested an apparatus in which a groove or a convex portion is formed on an inner metal surface of a chamber of a plasma processing apparatus and propagation of the MSW past the groove or the convex portion is suppressed by reflecting the MSW on groove or the convex portion (for example, refer to Patent document 1).

(Patent document 1) International Application Publication No. 2008/153054 pamphlet

### DISCLOSURE OF THE INVENTION

### Technical Problem

However, in a case where propagation of a MSW is suppressed by using a groove, electrons and ions of plasma, which are propagating the inside of groove, may recombine with each other on a side surface or a bottom surface of the groove, and accordingly, the electrons and ions are reduced in the groove. Thus, it is likely that plasma density in the groove is reduced, and it is difficult to generate plasma stably. On the other hand, once the plasma is generated in the groove, the strong plasma is generated.

Consequently, there is a portion where the plasma is generated and a portion where the plasma is not generated in the groove. That is, the plasma is locally generated in the groove. In addition, in the portion of the recess where the plasma is generated, the plasma density is very high, and the portion having high plasma density wanders around inside the groove. Thus, the plasma in the groove is in an unstable state temporally and spatially.

A propagation type of the MSW varies depending on the plasma density in the groove. If the plasma density is low, the MSW propagates through the groove. On the other hand, if the plasma density is high, the MSW cannot pass through the groove since it is reflected by the groove. As described above, since the plasma in the groove is unstable, the MSW passes through the groove or is reflected by the groove, and thus, a propagation state of the MSW changes temporally and spatially. The unstable change may affect all plasma outside the groove, and thus all plasma may become unstable.

In addition, if the propagation of the MSW is suppressed by a convex portion, the plasma may be stable, but it is difficult to sufficiently reflect the MSW.

Therefore, the present invention provides a plasma processing apparatus capable of controlling propagation of electromagnetic waves in a processing container in consideration of stability of plasma.

### Technical Solution

To solve the above problem, there is provided a plasma processing apparatus for plasma-processing an object to be processed by exciting a gas by electromagnetic waves, the plasma processing apparatus including: a processing container which is formed of metal; an electromagnetic wave source which outputs the electromagnetic wave; one or more first dielectric members which face an inner wall of the processing container so as to transmit the electromagnetic waves output from the electromagnetic wave source into the processing container; and a second dielectric member which is provided on an inner surface of the processing container and which restrains the electromagnetic waves from propagating along the inner surface of the processing container.

According to the above structure, the second dielectric member is provided on the inner surface of the processing container so as to restrain the electromagnetic waves (MSW) propagating along the inner surface of the processing container. The MSW propagates along a sheath. When propagation of the MSW reaches an end portion of the second dielectric member, the propagation type is greatly changed. When the MSW reaches the second dielectric member by propagating along the metal surface of the processing container, the MSW is changed to a DSW which propagate through the second dielectric member as an electric field is infiltrated into zo the second dielectric member. Therefore, the MSW changes into the DSW, and after propagating through the second dielectric member, the DSW changes again into the MSW. When the surface wave is changed from the MSW into the DSW or changed from the DSW into the MSW, a characteristic impedance changes sharply. Accordingly, the second dielectric member may reflect the electromagnetic wave propagating along the inner surface of the processing container.

Accordingly, it may prevent process uniformity from being damaged by the MSW which propagates to the neighborhood of an object to be processed along the inner surface of the processing container. In addition, it may prevent useless consumption of microwave energy caused by generation of the plasma on a location that may not be used to process the object to be processed. Also, it may restrain the MSW from propagating to an area where an apparatus may be damaged due to energy of the MSW.

The second dielectric member may reflect 90% or more of the electromagnetic waves propagating along the inner surface of the processing container.

In addition, the inner surface of the processing container may be, for example, a metal surface of an inner wall of the processing container to which the plasma contacts, a metal surface of the inner wall of the processing container, which define a space for plasma-processing the object to be processed, and a metal surface of the inner wall of the processing container, which is located (side of the first dielectric members) above a location where the object to be processed is placed.

A thickness Dₜ of the thickest portion of the second dielectric member in a direction perpendicular to a direction in which a metal surface wave propagates may be 4 mm or greater.

A length D_{w} of the longest portion of the second dielectric member in a direction in which a metal surface wave propagates may be a value excluding about n/2 (n is an integer) times a wavelength λ_{d} of the electromagnetic wave propagating through the second dielectric member.

The length D_{w} of the longest portion of the second dielectric member in the direction in which the metal surface wave propagates may be less than about ½ of the wavelength λ_{d} of the electromagnetic wave propagating through the second dielectric member.

The length D_{w} of the longest portion of the second dielectric member in the direction in which the metal surface wave propagates may be less than a following expression,

$$\frac{107}{f [ MHz ] \sqrt{{ɛ}_{d}}} [ m ]$$

where ∈_{d} denotes a relative dielectric constant of the second dielectric member and f denotes a frequency of the metal surface wave.

The length D_{w} of the longest portion of the second dielectric member in a direction in which a metal surface wave propagates may be about (2n+1)/4 (n is an integer) times a wavelength λ_{d} of the electromagnetic wave propagating through the second dielectric member.

The second dielectric member may be inserted in a penetration hole or a recess formed in the inner wall of the processing container.

The second dielectric member may contact a metal surface of the processing container.

An edge of at least a plasma side surface of the second dielectric member may be chamfered.

The second dielectric member may extend to a side wall of the processing container.

The second dielectric member may be provided at an area which surrounds a plasma exciting region on the inner surface of the processing container.

A plurality of the first dielectric members may be regularly arranged facing the inner wall of the processing container, and the second dielectric member may be provided along or adjacent to the outermost circumferential side of a plurality of cells that are virtual areas, each cell including one of the plurality of first dielectric members.

A plurality of the first dielectric members may be regularly arranged facing the inner wall of the processing container.

The second dielectric member may be provided along or adjacent to the outermost circumferential side of the plurality of first dielectric members and a cover provided adjacent to the plurality of first dielectric members.

The second dielectric member may define the plasma exciting region.

The metal surface may be exposed between the second dielectric member and the plurality of first dielectric members.

The second dielectric member may be fixed on the processing container by a fixing member or by a through hole or a recess formed in the processing container.

### Advantageous Effects

According to the present invention, there is provided a plasma processing apparatus that may inhibit propagation of electromagnetic waves that are propagated along an inner surface of a processing container while stabilizing plasma.

### BRIEF DESCRIPTION OF THE DRAWINGS

FIG. 1 is a longitudinal-sectional view (cross-sectional view taken along a line 2-O,O′-2) of a plasma processing apparatus according to an embodiment of the present invention;

FIG. 2 is a diagram (cross-sectional view taken along a line 1-1) showing a ceiling surface of the plasma processing apparatus according to the embodiment of the present invention illustrated in FIG. 1;

FIG. 3 is a diagram illustrating reflection of a surface wave by a second dielectric member;

FIG. 4 is a graph showing a relation between a thickness of the second dielectric member and a transmission amount;

FIG. 5 is a graph showing a relation between a width of the second dielectric member and the transmission amount;

FIG. 6 is a longitudinal-sectional view (cross-sectional view taken along a line 4-0′, 0-4) of a plasma processing apparatus according to another embodiment of the present invention;

FIG. 7 is a diagram (cross-sectional view taken along a line 3-3) showing a ceiling surface of the plasma processing apparatus according to the embodiment of the present invention illustrated in FIG. 6;

FIG. 8 is a longitudinal-sectional view showing a second dielectric member according to a modified example 1 of the present invention;

FIG. 9 is a longitudinal-sectional view showing a second dielectric member according to a modified example 2 of the present invention;

FIG. 10 is a longitudinal-sectional view showing a second dielectric member according to a modified example 3 of the present invention;

FIG. 11 is a longitudinal-sectional view showing a second dielectric member according to a modified example 4 of the present invention;

FIG. 12 is a longitudinal-sectional view showing a second dielectric member according to a modified example 5 of the present invention; and

FIG. 13 is a longitudinal-sectional view showing a second dielectric member according to a modified example 6 of the present invention.

### EXPLANATION ON REFERENCE NUMERALS

10: microwave plasma processing apparatus
100: processing container
105: susceptor
200: container body
300: lid
300a: upper lid
300b: lower lid
300b1: upper portion of the lower lid
300b2: lower portion of the lower lid
305: first dielectric member
310: metal electrode
320: metal cover
325, 500, 510, 515: screw
340: second dielectric member
340a: inclined surface
350: side cover

### BEST MODE FOR CARRYING OUT THE INVENTION

Hereinafter, the present invention will be described in detail by explaining exemplary embodiments of the invention with reference to the attached drawings. Like reference numerals in the drawings and the specification denote like elements, and overlapping descriptions thereof will be omitted.

In addition, a plasma processing apparatus according to an embodiment and modified examples of the present invention will be described in the following order.

<Embodiment 1>

[Structure of a plasma processing apparatus]

[reflection by a second dielectric member]

[optimal shape of the second dielectric member]
(thickness Dₜ of the second dielectric member)
(width D_{w} of the second dielectric member)

<Embodiment 2>

[Structure of a plasma processing apparatus]

[second dielectric member]

<Modified examples of the second dielectric member>
(modified example 1)□(modified example 6)<

### Embodiment 1

### Structure of the Plasma Processing Apparatus

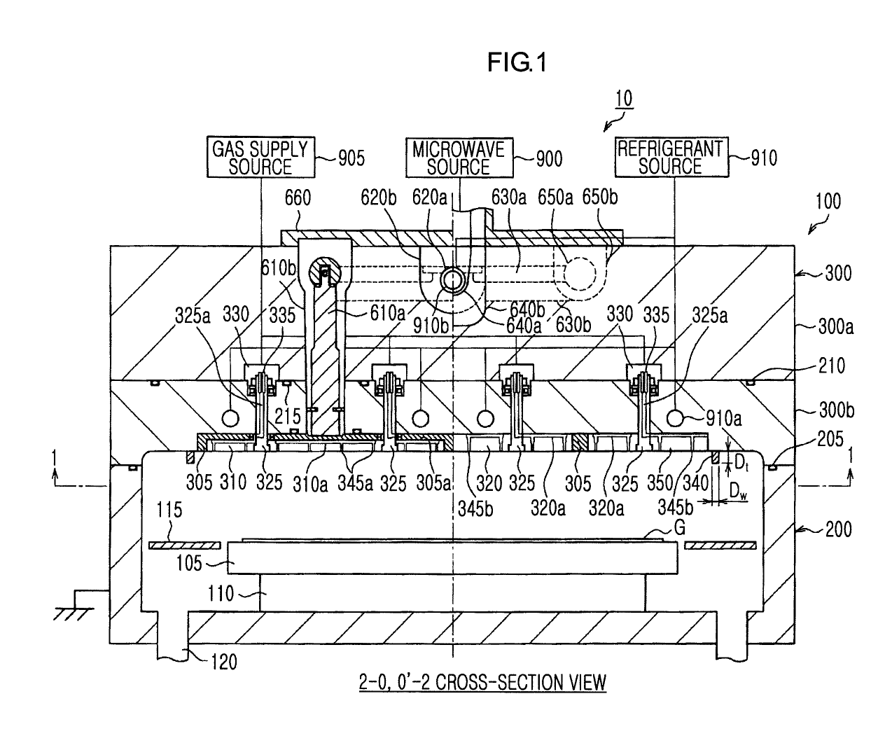

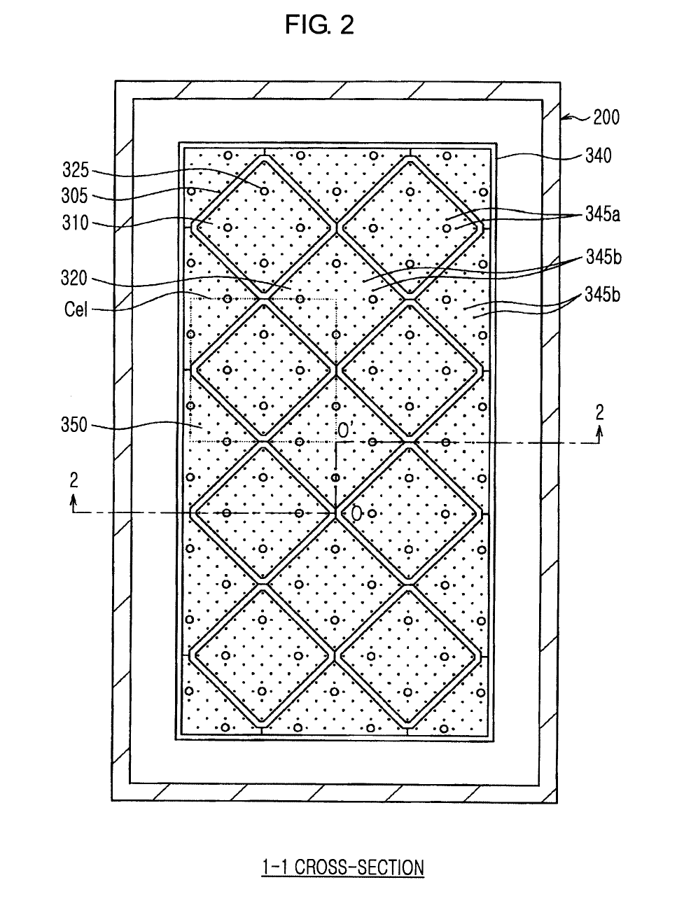

A structure of a microwave plasma processing apparatus according to an embodiment 1 of the present invention will now be described with reference to FIGS. 1 and 2. FIG. 1 is a longitudinal-sectional view (cross-sectional view taken along a line 2-O,O′-2 of FIG. 2) of a microwave plasma processing apparatus 10 according to the present embodiment. FIG. 2 is a cross-sectional view taken along a line 1-1 of FIG. 1 and shows a ceiling surface of the microwave plasma processing apparatus 10. The microwave plasma processing apparatus 10 is an example of a plasma processing apparatus that plasma-processes an object to be processed by exciting a gas by using electromagnetic waves.

As shown in FIG. 1, the microwave plasma processing apparatus 10 includes a processing container 100 for plasma-processing a glass substrate (hereinafter, referred to as a substrate G). The processing container 100 includes a container body 200 and a lid 300. The container body 200 has a cube shape having an opened top and a closed bottom, wherein the opened top is closed by the lid 300. The lid 300 is formed of an upper lid 300a and a lower lid 300b. An O-ring 205 is provided on a contacting surface between the container body 200 and the lower lid 300b, and accordingly, the container body 200 and the lower lid 300b are sealed, thereby defining a processing chamber. An O-ring 210 and an O-ring 215 are also provided on a contacting surface between the upper lid 300a and the lower lid 300b, and accordingly, the upper lid 300a and the lower lid 300b are sealed. The container body 200 and the lid 300 are formed of a metal, such as an aluminum alloy, or the like, and are electrically grounded.

A susceptor 105 (stage) on which the substrate G is placed is provided inside the processing container 100. The susceptor 105 is formed of, for example, aluminum nitride. The susceptor 105 is supported by a supporter 110, and a baffle plate 115 for controlling a flow of a gas of the processing chamber in a desirable state is provided around the susceptor 105. A gas exhaust pipe 120 is provided at a bottom part of the processing container 100, and a gas inside the processing container 100 is discharged by using a vacuum pump (not shown) provided outside the processing container 100.

Referring to FIG. 2, first dielectric members 305, metal electrodes 310, and metal covers 320 are regularly disposed on the ceiling surface of the processing container 100. 8 first dielectric members 305 and 8 metal electrodes 310 are disposed at regular pitches at a location having an angle of about 45° with respect to the substrate G or the processing container 100. Slightly cut corners of the first dielectric members 305 are adjacently disposed to each other. Three metal covers 320 are disposed between the first dielectric members 305 and the metal electrodes 310.

In addition, 12 side covers 350 are provided around the metal electrodes 310 and the metal covers 320 on the ceiling surface. The metal electrodes 310 and the metal covers 320 are each a plate having a nearly square shape in the present embodiment; but, the shape of the plate may not be the square shape. The metal electrodes 310 are flat plates provided adjacent to the first dielectric members 305 such that the first dielectric members 305 are nearly evenly exposed from a peripheral portion of the metal electrodes 310. According to the above structure, the first dielectric members 305 are sandwiched by an inner surface of the lid 300 and the metal electrodes 310, and then are closely adhered to an inner surface of the processing container 100. The metal electrodes 310 are electrically connected to the inner wall of the processing container 100.

Also, in the present embodiment, the 8 first dielectric members 305 and the 8 metal electrodes 310 are disposed in 2 rows and 4 columns, but the numbers of first dielectric members 305 and metal electrodes 310 are not limited thereto, and may be increased or reduced.

Referring to FIG. 1 again, regarding the metal electrodes 310 and the metal covers 320, the metal covers 320 are thicker than the metal electrodes 310 by as much as a thickness of the first dielectric members 305. As such, heights of the ceiling surface are nearly equal to one another. The first dielectric members 305 are formed of alumina, and the metal electrodes 310, the metal covers 320, and the side covers 350 are formed of an aluminum alloy.

The first dielectric members 305 and the metal electrodes 310 are evenly supported by screws 325 at 4 locations. A main gas passage 330 having a lattice shape in a direction perpendicular to the ground is provided between the upper lid 300a and the lower lid 300b. The main gas passage 330 distributes a gas to a gas passage 325a provided in the plurality of screws 325. A tubule 335 for narrowing the passage is inserted in inlet of the gas passage 325a. The tubule tubes 335 are formed of a ceramic or a metal. Gas passage 310a is provided between the metal electrode 310 and the first dielectric members 305. Gas passage 320a is also provided between the metal covers 320 and the lower lid 300b and between the side covers 350 and the lower lid 300b. A front end surface of the screws 325 forms one surface with bottom surfaces of the metal electrodes 310, the metal covers 320, and the side covers 350, so as not to scatter a distribution of plasma. Gas discharging holes 345a opened on the metal electrodes 310 and gas discharging holes 345b opened on the metal covers 320 or the side covers 350 are formed at regular pitches.

A gas output from a gas supply source 905 passes from the main gas passage 330 to the gas passage 325a, passes through the gas passage 310a and the gas passage 320a, and is supplied from the gas discharging holes 345a and 345b into the processing chamber. As such, etching of a surface of a dielectric member plate due to ions in plasma and deposition of reaction products on an inner wall of a processing container, which conventionally occurred by forming a gas shower plate on a metal surface of a ceiling unit, are suppressed, thereby promoting reduction of contamination or particles. Also, unlike a dielectric member, metal is easily processed, and thus expenses may be remarkably reduced.

An outer conductor 610b of a first coaxial waveguide is formed by engraving the lid 300, and an inner conductor 610a is inserted into the engraved location of the outer conductor 610b. Inner conductors 620a through 650a of second through fifth coaxial waveguides are respectively inserted into outer conductors 620b through 650b which are formed by engraving the lid 300, of the second through fifth coaxial waveguides and tops of the first coaxial waveguide 610 and the second through fourth coaxial waveguides are covered by a lid cover 660. The inner conductors of the coaxial waveguides are formed of copper having good thermal conductivity.

A surface of the first dielectric members 305 is coated with a metal film 305a, except for an area where a microwave is incident on the first dielectric members 305 from between the inner conductor 610a and the outer conductor 610b of the first coaxial waveguide 610 and an area where the microwave is discharged into the processing container 100 from the first dielectric members 305. Accordingly, propagation of the microwave is not disturbed even by a gap generated between the first dielectric members 305 and a member near the first dielectric members 305, and thus the microwave may be stably introduced into the processing container 100.

The first dielectric members 305 are exposed from between the metal electrodes 310 adjacent to the first dielectric members 305 in a one-to-one correspondence, and the metal covers 320 where the first dielectric members 305 are not disposed, toward the plasma side. As shown in FIG. 2, a virtual area having center points of the adjacent metal covers 320 around each of the first dielectric members 305 as a vertex will now be referred to as a cell Cel, and the ceiling surface is partitioned into equal virtual areas. In the ceiling surface, one cell Cel is used as one unit, and 8 cells Cel are regularly arranged, wherein the 8 cells Cel have the same pattern.

Accordingly, the microwave having a frequency of, for example, 915 MHz, output from a microwave source 900 is evenly transferred to the first dielectric members 305 after passing through the first through fifth coaxial waveguides. The microwave discharged from the first dielectric members 305 becomes a surface wave and propagates along surfaces of the metal electrodes 310 and the metal covers 320 while evenly distributing electric power. Accordingly, a metal surface wave (MSW) propagates on the entire ceiling surface, and thus the plasma is evenly generated below the ceiling surface of the microwave plasma processing apparatus 10 of the present embodiment.

A second dielectric member 340 is provided to surround all of the first dielectric members 305, the metal electrodes 310, the metal covers 320, and the side covers 350 along outermost circumferential sides of all the plurality of cells Cel. The second dielectric member 340 has a longitudinal cross-section formed as a rectangle, and is formed of quartz, alumina, Yttria, a compound of alumina and quartz, or the like. An upper surface of the second dielectric member 340 is closely adhered to a lower surface of the lower lid 300b so as to protrude from the lower lid 300b toward the plasma.

As described above, the second dielectric member 340 is provided adjacent to the outermost circumferential sides of all the plurality of cells Cel, which are the virtual areas, each cell including one of the plurality of first dielectric members 305. The plurality of first dielectric members 305 and the second dielectric member 340 are close to each other, but do not contact each other. In addition, the metal surface is exposed between the second dielectric member 340 and the plurality of first dielectric members 305. The second dielectric member 340 is provided at a region surrounding a plasma exciting area on the inner surface of the processing container 100. The second dielectric member 340 may be formed to have a single layer like in the present embodiment, or dual or triple layers. The second dielectric member 340 is provided on the inner surface of the processing container 100 to restrain the electromagnetic wave (the MSW) propagating along the inner surface of the processing container 100, and will be described later in more detail.

A refrigerant supply source 910 shown in FIG. 1 is connected to a refrigerant pipe 910a inside the lid 300 and a refrigerant pipe 910b inside the inner conductor 620a of the second coaxial waveguide, and a refrigerant supplied from the refrigerant supply source 910 circulates inside the refrigerant pipes 910a and 910b and returns back to the refrigerant supply source 910 to prevent the lid 300 and the inner conductor 620a of the second coaxial waveguide from being heated.

### Reflection by the Second Dielectric Member

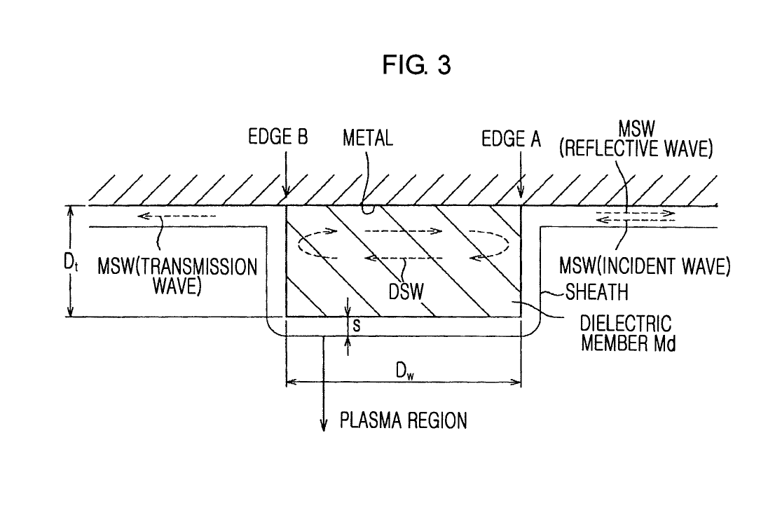

In order to restrain the transmission of the MSW to be sufficiently low, a width and a thickness of the second dielectric member 340 need to be desired values. In order to obtain an optimal width and thickness of the second dielectric member 340, an electromagnetic field simulation was performed by using a model illustrated in FIG. 3. As shown in FIG. 3, a dielectric member Md having a thickness Dₜ and a width D_{w} and extending infinitely in a direction perpendicular to the paper surface is disposed on a lower surface of a metal. A sheath having a thickness s and plasma having a relative dielectric constant ∈_{d} are formed on lower surfaces of the metal and the dielectric member Md. A relative dielectric constant of the sheath is set as 1.

Some of an incident wave of the MSW that propagates on a surface of the metal from a right end of the drawing to a left portion becomes a dielectric member surface wave (DSW) and propagates through the dielectric member Md, when the incident wave reaches an edge A of the dielectric member Md. In addition, a remaining portion of the incident wave of the MSW becomes a reflective wave and returns. The microwave is reflected not only by the edge A, but also by an edge B. A standing wave is generated in the dielectric member Md by the microwave that is propagating to left and right sides due to multiple reflection on the edges A and B. Some of the DSW becomes a transmission wave of the MSW at the edge B and propagates along a surface of the metal on the left side.

When it is assumed that electric power of the incident wave is Pᵢ and electric power of the transmission wave is Pₜ, a transmission amount is 10 log(Pₜ/Pᵢ). For practical usage, the electric power of the transmission wave should be maintained to be less than 10% of that of the incident wave. Therefore, the transmission amount has to be maintained to be less than −10 dB.

### Optimal Shape of the Dielectric Member

(Thickness Dₜ of the Dielectric Member)

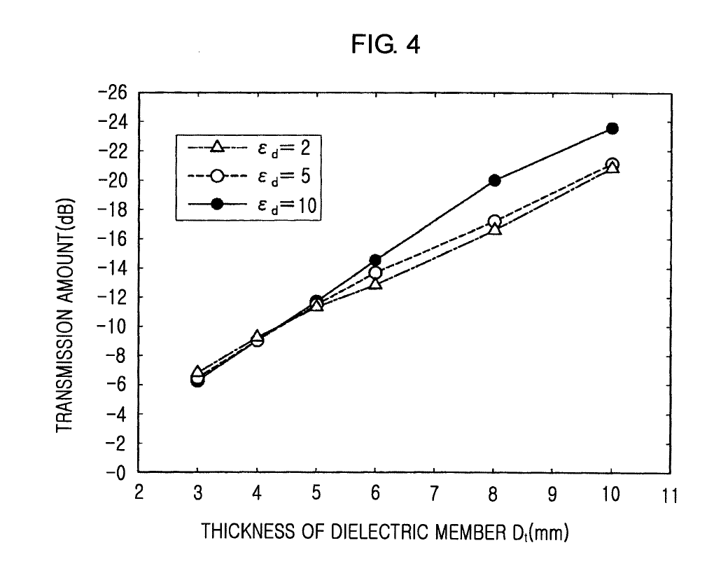

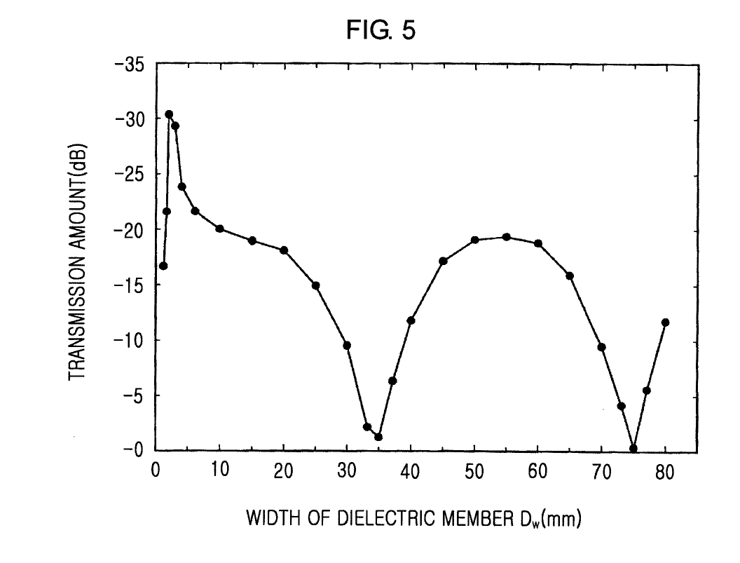

Next, results of the electromagnetic simulation performed by using the model shown in FIG. 3 are shown in FIGS. 4 and 5. FIG. 4 illustrates a relation between the thickness Dₜ of the dielectric member and the transmission amount. The width D_{w} of the dielectric member was fixed at 10 mm. A frequency of the microwave was 915 MHz and the relative dielectric constant ∈_{d} of the plasma was −70. The above values were included in standard conditions for exciting the plasma.

As shown in FIG. 4, the transmission amount is reduced when the thickness Dₜ of the dielectric member is increased. This will be described as follows. At the edge A, as a ratio between characteristic impedances of the MSW and the DSW is increased, the reflection is increased and the transmission is reduced. Since the DSW propagates throughout the thick dielectric member, as well as through the sheath formed along the surface of the thick dielectric member, the characteristic impedance of the DSW is generally greater than that of the MSW. The characteristic impedance of the DSW is increased when the thickness Dₜ of the dielectric member becomes greater. Therefore, as the thickness Dₜ of the dielectric member is increased, the ratio between the characteristic impedances of the MSW and the DSW is increased and the transmission amount is reduced.

On the other hand, as shown in FIG. 4, the transmission amount is hardly dependent upon a relative dielectric constant ∈_{d} of the dielectric member. In addition, in order to maintain the transmission amount to be less than −10 dB, the thickness Dₜ of the dielectric member has to be 4 mm or greater regardless of the relative dielectric constant ∈_{d} of the dielectric member.

(Width D_{w} of the Dielectric Member)

FIG. 5 illustrates a relation between the width D_{w} of the dielectric member and the transmission amount. A frequency of the microwave was 915 MHz, the relative dielectric constant of the plasma was −70, the thickness Dₜ of the dielectric member was 8 mm, and the relative dielectric constant ∈_{d} of the dielectric member was 10. The transmission amount periodically changes with respect to the width D_{w} of the dielectric member. This will be described as follows.

As described above, standing waves are generated in the dielectric member due to the microwave propagating in left-and-right directions. Since impedance seen from the edge B toward left side is sufficiently less than the characteristic impedance of the DSW, the edge B is nearly an electrically short, and thus the edge B becomes a node of the standing wave in an electric field.

When the edge A is an antinode of the standing wave, that is, when the width D_{w} of the dielectric member is about (2n+1)×λ_{d}/4 (n is an integer and λ_{d} is a wavelength of the DSW), since an impedance seen from the edge A toward left side is maximized and a ratio with respect to the small characteristic impedance of the MSW is increased, the transmission amount is minimized.

On the other hand, when the edge A is a node of the standing wave, that is, when the width D_{w} of the dielectric member is n×λ_{d}/2, the impedance seen from the edge A toward left side is minimized and the ratio with respect to the characteristic impedance of the MSW is reduced, and thus the transmission amount is maximized.

In order to restrain the transmission amount to be low, it is preferable that the antinode of the standing wave is on the edge A, that is, the width D_{w} of the dielectric member is about (2n+1)×λ_{d}/4. Otherwise, it is preferable that the node of the standing wave is not on the edge A, that is, the width D_{w} of the dielectric member is the width other than n×λ_{d}/2. In addition, in order to restrain the transmission amount always to be low even when the wavelength λ_{d} of the DSW changes due to various conditions, it is preferable that the width D_{w} of the dielectric member is λ_{d}/2 or less.

When the thickness Dₜ of the dielectric member is sufficiently greater than the thickness of the sheath, the wavelength λ_{d} of the DSW may be approximately calculated as follows. First, an eigenvalue hᵢ is calculated from the following characteristic equation.

∈_{d}\sqrt{hᵢ²+(∈_{d}−∈ₚ)k₀²}+∈ₚhᵢ tan h(hᵢDₜ)=0 (1)

Here, ∈ₚ denotes a relative dielectric constant of the plasma (real part) and k₀ denotes a wave number in a vacuum state. Next, the wavelength λ_{d} of the DSW is calculated from following equation.

$${λ}_{d} = \frac{2 π}{\sqrt{{ɛ}_{d} {k}_{0}^{2} + {h}_{i}^{2}}} \qquad ( 2 )$$

Under conditions where the results shown in FIG. 5 are obtained, when the wavelength λ_{d} of the DSW is calculated by using above equations (1) and (2), the wavelength λ_{d} is 74 mm. Referring to FIG. 5, when the width D_{w} of the dielectric member is nearly equal to a value of n×λ_{d}/2 (n=1,2), the transmission amount is the largest.

The wavelength λ_{d} of the DSW is nearly inversely proportional to the frequency f of the microwave, and nearly inversely proportional to power of ½ of the relative dielectric constant ∈_{d} of the dielectric member. Therefore, the wavelength λ_{d} of the DSW may be simply represented by the following equation.

$${λ}_{d} [ m ] \approx \frac{215}{f [ MHz ] \sqrt{{ɛ}_{d}}} \qquad ( 3 )$$

In order to restrain the transmission amount to be low even when the wavelength λ_{d} of the DSW changes according to various conditions, the width D_{w} of the dielectric member need to be less than at least λ_{d}/2, that is, the following inequality needs to be formed from above equation (3).

$${D}_{w} [ m ] < \frac{107}{f [ MHz ] \sqrt{{ɛ}_{d}}} \qquad ( 4 )$$

From the above description, a thickness Dₜ and a width D_{w} of the second dielectric member 340 may be set as follows. That is, it is preferable that the thickness Dₜ of the thickest portion of the second dielectric member 340 in a direction perpendicular to the propagation direction of the MSW is 4 mm or greater.

In addition, it is preferable that a length D_{w} of the longest portion of the second dielectric member 340 in the propagation direction of the MSW is about (2n+1)×λ_{d}/4 (n is an integer), or a value other than n×λ_{d}/2 (n is an integer). It is more preferable that the length D_{w} of the second dielectric member 340 is less than about λ_{d}/2.

According to the above description, the MSW propagating along the inner surface of the processing container 100 may be sufficiently reflected by the second dielectric member 340, and thus the plasma exciting region is defined as a region surrounded by the second dielectric member 340. Accordingly, it may prevent process uniformity from being damaged by the MSW which propagates to the neighborhood of the substrate G along the inner surface of the processing container. In addition, it may prevent useless consumption of microwave energy caused by generation of the plasma on a location that may not be used to process the substrate G. Also, it may restrain the MSW from propagating to an area where an apparatus may be damaged due to energy of the MSW.

### Embodiment 2

### Structure of the Plasma Processing Apparatus

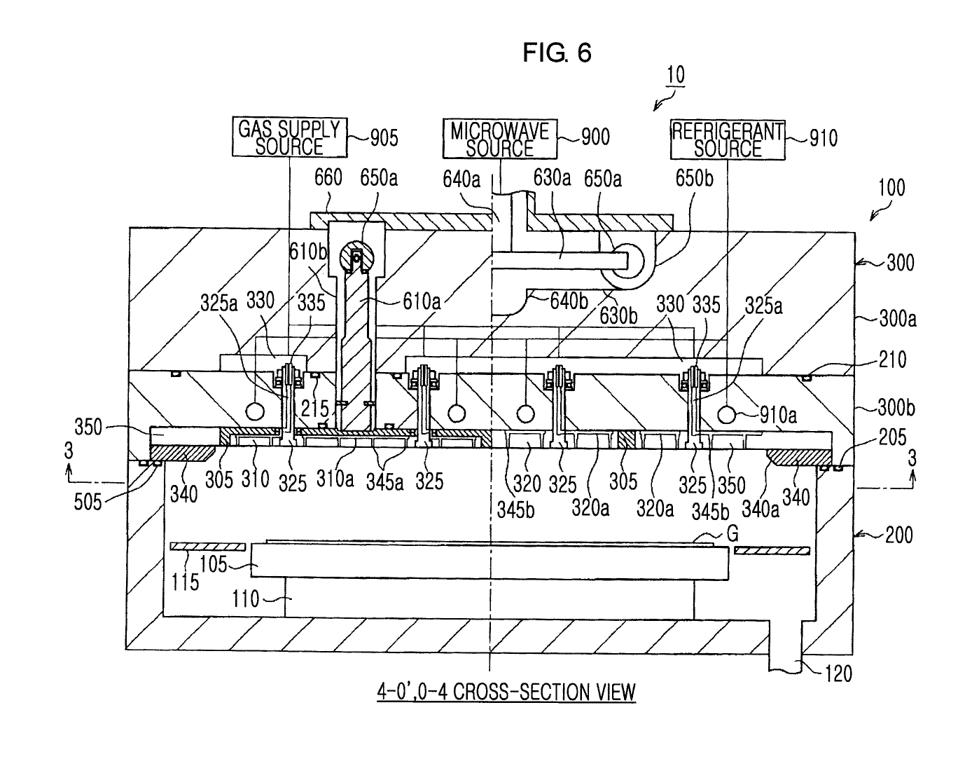

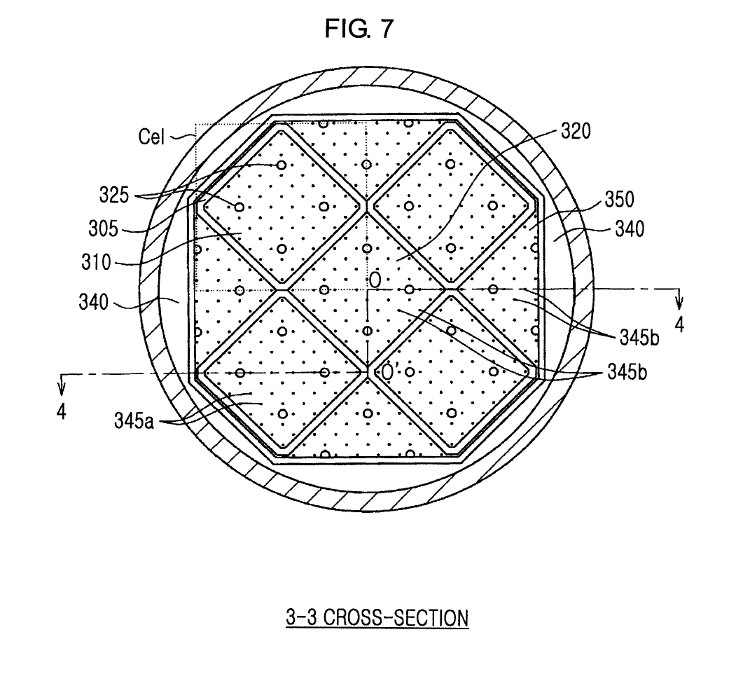

A structure of a microwave plasma processing apparatus according to an embodiment 2 of the present invention will now be described with reference to FIGS. 6 and 7. FIG. 6 is a zo longitudinal cross-sectional view (cross-sectional view taken along a line 4-O′,O-4 of FIG. 7) of the microwave plasma processing apparatus 10 according to the present embodiment. FIG. 7 is a cross-sectional view taken along a line 3-3 of FIG. 6 and a diagram showing a ceiling surface of the microwave plasma processing apparatus 10.

The microwave plasma processing apparatus 10 includes a processing container 100 for plasma-processing a semiconductor substrate G of 300 mm, for example. The processing container 100 includes a container body 200 and a lid 300. The container body 200 has a cylinder shape having an opened top and a closed bottom, wherein the opened top is closed by the lid 300.

Referring to FIG. 7, first dielectric members 305, metal electrodes 310, and metal covers 320 are regularly arranged on the ceiling surface of the processing container 100. 4 first dielectric members 305 and 4 metal electrodes 310 are disposed point-symmetrically with each other such that slightly cut corners of the 4 first dielectric members 305 are adjacently disposed. One sheet of the metal cover 320 is disposed between the first dielectric members 305 and the metal electrodes 310.

Side covers 350 are integrally formed and provided on the ceiling surface so as to surround all of the first dielectric members 305, the metal electrodes 310, and the metal covers 320. The metal electrodes 310 and the metal covers 320 are each a plate having a nearly square shape in the present embodiment; but, the shape of the plate may not be the square shape. According to the above structure, the first dielectric members 305 are sandwiched by an inner wall of the lid 300 and the metal electrodes 310, and then are closely adhered to an inner surface of the processing container 100. The metal electrodes 310 are electrically connected to an inner wall of the processing container 100.

Referring to FIG. 6 again, an outer conductor 610b of a first coaxial waveguide is formed by engraving the lid 300, and an inner conductor 610a is inserted into the engraved location of the outer conductor 610b. Inner conductors 630a through 650a of third through fifth coaxial waveguides are respectively inserted into outer conductors 630b through 650b, which are formed by engraving the lid 300, of the third through fifth coaxial waveguides, and tops of the first coaxial waveguide 610 and the second through fourth coaxial waveguides are covered by a lid cover 660. The fourth coaxial waveguide diverges into the third coaxial waveguide, and the third coaxial waveguide diverges into the fifth coaxial waveguides, which are connected to two end portions of the third coaxial waveguide. The first coaxial waveguides are connected to two end portions of the fifth coaxial waveguides.

A microwave output from a microwave source 900 is supplied into the processing container 100 from the four first dielectric members 305 through the fourth coaxial waveguide, the third coaxial waveguide, the two fifth coaxial waveguides, and the four first coaxial waveguides.

### Second Dielectric Member

As shown in FIG. 6, the second dielectric member 340 according to the second embodiment has a cross-section that is elongated in a transverse direction. The second dielectric member 340 extends into a side wall of the processing container 100 (container body 200). An outer circumferential side of the second dielectric member 340 is inserted into a recess that is formed on a boundary between the container body 200 and the lower lid 300b. An O-ring 505 is disposed on a lower surface of the recess so that the second dielectric member 340 may be pushed by a repulsive force of the O-ring 505 to be fixed on the lower lid 300b. According to the above structure, the second dielectric member 340 may be fixed by the recess formed on the processing container 100 without using a fixing member.

As shown in FIGS. 6 and 7, in the present embodiment, the second dielectric member 340 is a plate formed as a ring having an octagonal opening, and a part of an inner circumference of the second dielectric member 340 is formed to be adjacent to outer sides of the 4 first dielectric members 305. Accordingly, the first dielectric members 305 and the second dielectric member 340 are slightly separated from each other, and a metal surface is exposed between the first and second dielectric members 305 and 340. A lower surface of the metal electrodes 310 and an upper surface of the second dielectric member 340 are located on the same plane.

In addition, a part of the inner circumference of the second dielectric member 340 may be formed along the outer sides of the 4 first dielectric members 305.

It is not desirable to form a large step in the processing container 100 because flow of the processing gas may be stopped. On the other hand, the second dielectric member 340 may be formed to be thick in order to reflect the MSW. Accordingly, an edge of at least a surface of the second dielectric member 340 that faces the plasma may be chamfered to form an inclined surface 340a so as to ensure a sufficient thickness of the second dielectric member 340 while maintaining a step generated due to the second dielectric member 340 to be small.

According to the above structure, the MSW propagating along the inner surface of the processing container 100 may be sufficiently reflected by the second dielectric member 340, and thus a region surrounded by the second dielectric member 340 is defined as the plasma exciting region.

### Modified Examples of the Second Dielectric Member

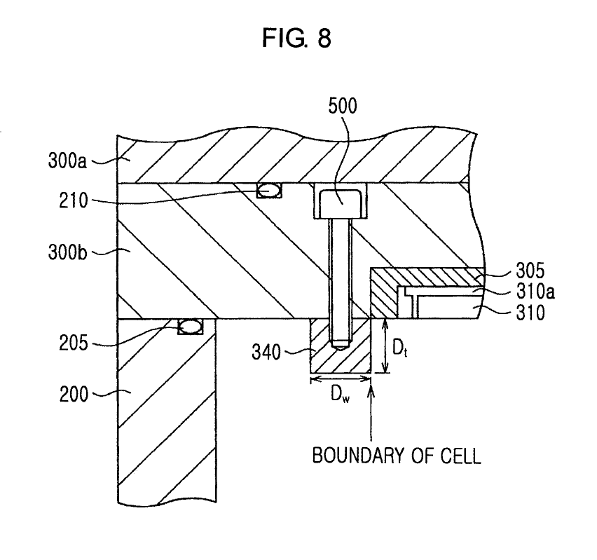

There may be considered various modified examples about the shape, a fixing method, and the arrangement of the second dielectric member 340. Hereinafter, modified examples 1 through 6 of the second dielectric member 340 will be described with reference to FIGS. 8 through 13.

### Modified Example 1

FIG. 8 is a longitudinal cross-sectional view of the second dielectric member 340 according to the modified example 1 of the present embodiment of the present invention. The second dielectric member 340 according to the modified example 1 has a rectangular cross-section, and is disposed such that a boundary between cells Cel and the edge of the second dielectric member 340 are located on the same plane. That is, the second dielectric member 340 is provided along the outermost circumference of a plurality of cells Cel that are virtual areas, each including one of the plurality of first dielectric members 305.

In addition, the second dielectric member 340 is fixed by a screw 500 from an upper portion (outer side) of the lower lid 300b in a state where the second dielectric member 340 contacts a metal surface of the ceiling surface of the processing container 100. The screw 500 may be formed of an insulating material, or a metal. According to the above structure, the lower surface of the metal electrodes 310 and the upper surface of the second dielectric member 340 are located on the same plane. Therefore, there is no need to process the lid, and expenses may be reduced.

In addition, since the second dielectric member 340 may be located on the boundary of the cells, it is easy to design the apparatus, and at the same time, a pattern always having a symmetric electric field may be obtained even when the wavelength of the microwave is changed.

Unless a gap between the metal surface of the processing container 100 and the second dielectric member 340 is maintained narrow, the plasma is generated at the gap. To avoid this, the gap is maintained to be 0.2 mm or less, for example.

### Modified Example 2

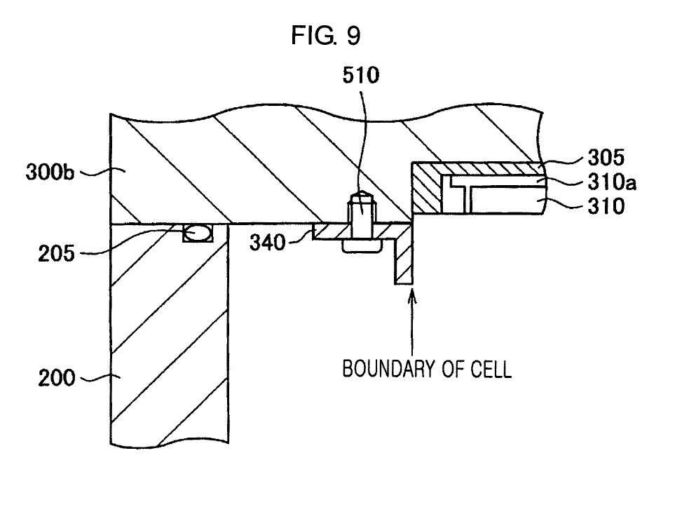

FIG. 9 is a longitudinal cross-sectional view of the second dielectric member 340 according to the modified example 2 of the present embodiment. The second dielectric member 340 according to the modified example 2 has an L-shaped cross-section, and the boundary of the cells Cel and the edge of the second dielectric member 340 are located on the same plane.

The second dielectric member 340 is fixed by a screw 510 from a lower side (inner side) of the lower lid 300b in a state where the second dielectric member 340 contacts the metal surface of the ceiling surface of the processing container 100. The screw may be formed of an insulating material, or a metal. The boundary of the cells Cel and the edge of the first dielectric member 305 are located on the same plane. The upper surface of the second dielectric member 340 is located slightly below the lower surface of the metal electrodes 310.

According to the above structure, since the second dielectric member 340 is fixed by a screw from the lower side, a maintenance property of the apparatus is improved. In addition, since the second dielectric member 340 is formed to have an L-shape, a partition of the second dielectric member 340 may be formed between a screw 510 and the plasma, and accordingly, an abnormal discharge may be prevented.

### Modified Example 3

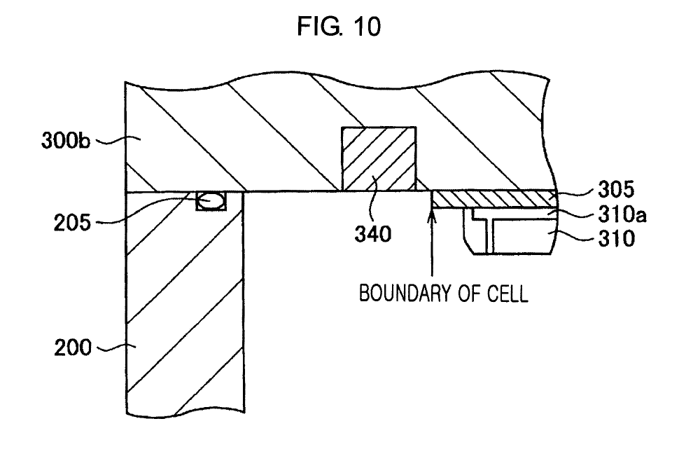

FIG. 10 is a longitudinal cross-sectional view of the second dielectric member 340 according to the modified example 3 of the present embodiment. According to the modified example 3, the second dielectric member 340 having a rectangular cross-section is completely embedded in the lower lid 300b so as not to protrude from the lower lid 300b. The lower surface of the second dielectric member 340 is located on the same plane as the upper surface of the first dielectric members 305. Accordingly, irregularity of the ceiling surface is reduced as much as possible so that flow of a gas may not be stopped. In addition, the edge of the second dielectric member 340 is located on an outer side of the boundary of the cells Cel. In the present modified example, the metal covers 320 and the side covers 350 are not provided.

### Modified Example 4

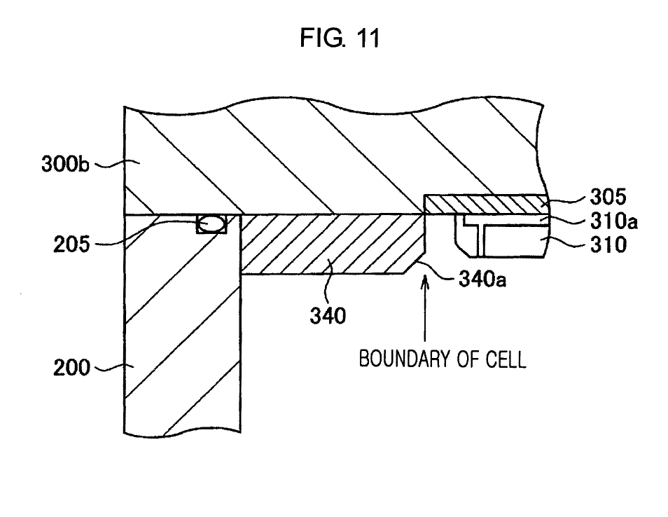

FIG. 11 is a longitudinal cross-sectional view of the second dielectric member 340 according to the modified example 4 of the present embodiment. According to the modified example 4, the edge of the second dielectric member 340 extends to an inner side surface of the container body 200 of the processing container 100 so as to contact the inner side surface. The boundary of the cells Cel and the edge of the second dielectric member 340 are located on the same plane.

The upper surface of the second dielectric member 340 and the lower surface of the first dielectric members 305 are located on the same plane. A corner of the second dielectric member 340 is chamfered to form an inclined surface 340a so that a gas flows smoothly and a cleaning process is performed easily. In the present modified example, the metal covers 320 and the side covers 350 are not provided.

### Modified Example 5

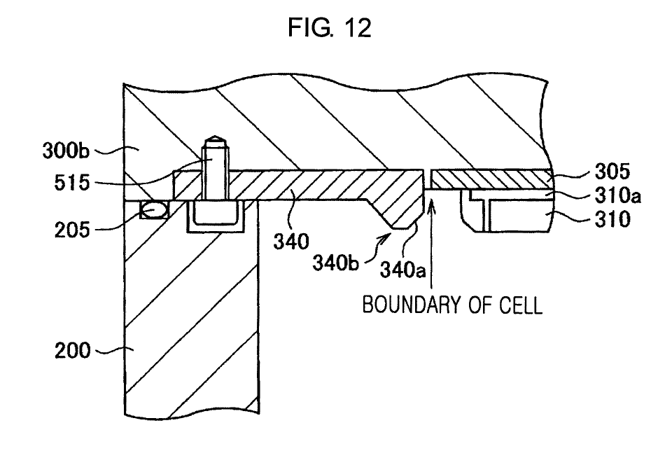

FIG. 12 is a longitudinal cross-sectional view of the second dielectric member 340 according to the modified example 5 of the present embodiment. According to the modified example 5, the second dielectric member 340 is partially embedded in the lower lid 300b, and a part of the second dielectric member 340 protrudes from the lower lid 300b. The second dielectric member 340 is fixed to the lower lid 300b by a screw 515 formed in a wall of the processing container. Since the screw 515 is not exposed to the plasma, an abnormal discharge may be prevented.

The second dielectric member 340 of the present modified example has a thin and long cross-section, and an inner side 340b of the second dielectric member 340 is thick and an edge of the second dielectric member 340 is chamfered to form an inclined surface 340a. The cross-section of the second dielectric member 340 is located at an outer side of the boundary of the cell Cel.

### Modified Example 6

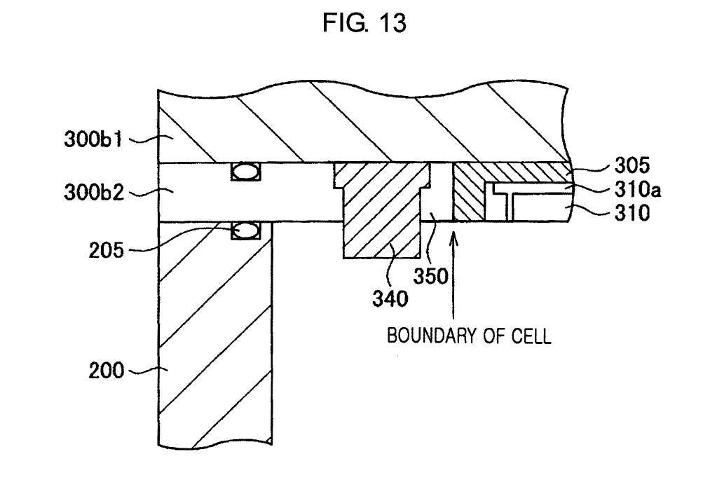

FIG. 13 is a longitudinal cross-sectional view of the second dielectric member 340 according to the modified example 6 of the present embodiment. According to the modified example 6, the lower lid 300b is divided into an upper portion 300b1 and a lower portion 300b2. The second dielectric member 340 is provided between the lower portion 300b2 of the lower lid and the side covers 350. A step is formed between the lower portion 300b2 and the side covers 350 so that the second dielectric member 340 may be inserted between the lower portion 300b2 of the lower lid 300b and the side covers 350 to be held. Accordingly, the second dielectric member 340 may be fixed without using a screw, or the like.

Stability of the plasma may be maintained and the propagation of the MSW may be restrained by the second dielectric member 340 according to the modified examples 1 through 6 described above.

The present invention has been particularly shown and described with reference to exemplary embodiments thereof, but the present invention is not limited thereto. It will be understood by those of ordinary skill in the art that various changes in form and details may be made therein without departing from the spirit and scope of the present invention as defined by the following claims.

For example, the second dielectric member 340 may be provided on the inner surface of the processing container 100, which surrounds the plasma exciting region. On the other hand, the second dielectric member 340 allows the region surrounded by the second dielectric member 340 to be defined as the plasma exciting region. The first and second dielectric members 305 and 340 may not be formed as plates.

In addition, in the above embodiments, the microwave source 900 outputting the microwave having a frequency of 915 MHz is illustrated; however, a microwave source for outputting the microwave having a frequency of 896 MHz, 92 MHz, 2.45 GHz, or the like may be used. In addition, the microwave source is an example of an electromagnetic wave source for generating a electromagnetic wave for exciting the plasma, and a magnetron or an RF power generator may be used as the electromagnetic wave source outputting the electromagnetic wave having a frequency of 100 MHz or greater.

A plasma processing apparatus according to the present invention is not limited to the above-described microwave plasma processing apparatuses, and may be any plasma processing apparatus as long as it performs, on an object to be processed, plasma process, such as film formation, diffusion, etching, ashing, plasma doping, and the like.

The plasma processing apparatus according to the present invention may process a large-area glass substrate, a circular silicon wafer, or an angular SOI (Silicon On Insulator) substrate.

1. A plasma processing apparatus for plasma-processing an object to be processed by exciting a gas by electromagnetic waves, the plasma processing apparatus comprising:
a processing container which is formed of metal;
an electromagnetic wave source which outputs the electromagnetic wave;
one or more first dielectric members which face an inner wall of the processing container so as to transmit the electromagnetic waves output from the electromagnetic wave source into the processing container; and
a second dielectric member which is provided on an inner surface of the processing container and restrains the electromagnetic waves from propagating along the inner surface of the processing container.

2. The plasma processing apparatus of claim 1, wherein the second dielectric member reflects the electromagnetic waves propagating along the inner surface of the processing container.

3. The plasma processing apparatus of claim 2, wherein the second dielectric member reflects 90% or more of the electromagnetic waves propagating along the inner surface of the processing container.

4. The plasma processing apparatus of claim 1, wherein a thickness Dₜ of the thickest portion of the second dielectric member in a direction perpendicular to a direction in which a metal surface wave propagates is 4 mm or greater.

5. The plasma processing apparatus of claim 1, wherein a length D_{w} of the longest portion of the second dielectric member in a direction in which a metal surface wave propagates is a value excluding about n/2 (n is an integer) times a wavelength λ_{d} of the electromagnetic wave propagating through the second dielectric member.

6. The plasma processing apparatus of claim 5, wherein the length D_{w} of the longest portion of the second dielectric member in the direction in which the metal surface wave propagates is less than about ½ of the wavelength λ_{d} of the electromagnetic wave propagating through the second dielectric member.

7. The plasma processing apparatus of claim 6, wherein the length D_{w} of the longest portion of the second dielectric member in the direction in which the metal surface wave propagates is less than a following expression,
$$\frac{107}{f [ MHz ] \sqrt{{ɛ}_{d}}} [ m ]$$
where ∈_{d} denotes a relative dielectric constant of the second dielectric member and f denotes a frequency of the metal surface wave.

8. The plasma processing apparatus of claim 1, wherein the length D_{w} of the longest portion of the second dielectric member in a direction in which a metal surface wave propagates is about (2n+1)/4 (n is an integer) times a wavelength λ_{d} of the electromagnetic wave propagating through the second dielectric member.

9. The plasma processing apparatus of claim 1, wherein the second dielectric member is inserted in a through hole or a recess formed in the inner wall of the processing container.

10. The plasma processing apparatus of claim 1, wherein the second dielectric contacts a metal surface of the processing container.

11. The plasma processing apparatus of claim 1, wherein an edge of at least a plasma side surface of the second dielectric member is chamfered.

12. The plasma processing apparatus of claim 1, wherein the second dielectric member extends to a side wall of the processing container.

13. The plasma processing apparatus of claim 1, wherein the second dielectric member is provided at an area which surrounds a plasma exciting region on the inner surface of the processing container.

14. The plasma processing apparatus of claim 1, wherein a plurality of the first dielectric members are regularly arranged facing the inner wall of the processing container, and the second dielectric member is provided along or adjacent to the outermost circumferential side of a plurality of cells that are virtual areas, each cell including one of the plurality of first dielectric members.

15. The plasma processing apparatus of claim 1, wherein a plurality of the first dielectric members are regularly arranged facing the inner wall of the processing container, and the second dielectric member is provided along or adjacent to the outermost circumferential side of the plurality of first dielectric members and a cover provided adjacent to the plurality of first dielectric members.

16. The plasma processing apparatus of claim 12, wherein the second dielectric member defines the plasma exciting region.

17. The plasma processing apparatus of claim 14, wherein a metal surface is exposed between the second dielectric member and the plurality of first dielectric members.

18. The plasma processing apparatus of claim 1, wherein the second dielectric member is fixed on the processing container by a fixing member or by a through hole or a recess formed in the processing container.
